(19) United States
(12) Patent Application Publication
(10) Pub. No.: US 2010/0185939 A1
(43) Pub. Date: Jul. 22, 2010

(54) THREE-DIMENSIONAL MARK-UP STYLE SHEET PROVISION FOR VIRTUAL WORLDS

(75) Inventors: Richard Greene, Winchester (GB); Conor P. Beverland, Chicago, IL (US); Florence Hirondel, Uccle (BE); Ailun Yi, Edinburg (GB); Tim Kock, Bramberg am Wildkogel (AT)

Correspondence Address: IBM - EU c/o Myers Andras Sherman LLP, 19900 MacArthur Blvd., Suite 1150, Irvine, CA, 92612, US

(73) Assignee: International Business Machines Corporation, Armonk, NY (US)

(21) Appl. No.: 12/356,023

(22) Filed: Jan. 19, 2009

(51) Int. Cl. G06F 17/00; G06F 3/048

(52) U.S. Cl. 715/235; 715/757

(57) ABSTRACT

A method and system for changing three-dimensional virtual world style. The method includes creating a three-dimensional style sheet by adding a plurality of mark-up tags to a body of data describing a virtual world environment, the mark-up tags including a plurality of modifiers, and modifying the plurality of modifiers to change the style of the virtual world environment according to at least one mark-up instruction.

### BACKGROUND

1. Field of the Invention

The present invention relates generally to three-dimensional environments. In particular, the present invention relates to quickly modifying the style of three-dimensional environments.

2. Background Information

As internet based 3-D virtual worlds (VW) become more and more ubiquitous, individuals and businesses across a variety of industries are creating a presence in these worlds for many purposes, including social networking, advertising and sales. Users of these VWs are able to create objects, services and a plurality of other business opportunities in-world that could help the individual or company gain revenue, launch products or services, and provide customers with a rich information base for learning and buying opportunities.

At the moment, existing three-dimensional layouts in VWs take time and effort to construct. Given a set of positioning data for objects and their dimensions, space can be generated within a given 3-D environment. However, if a variant or variants are desired on the layout, then all of the objects to be moved and dimensions to be changed must either be altered in-world or the layout description changed elsewhere and the new layout created. For example, a single set of rooms all of roughly the same layout might be desired, and each room would have to have its own, independent, description of what to place and where.

### BRIEF SUMMARY

A method and system for changing three-dimensional virtual world style. The method includes creating a three-dimensional style sheet by adding a plurality of mark-up tags to a body of data describing a virtual world environment, the mark-up tags including a plurality of modifiers, and modifying the plurality of modifiers to change the style of the virtual world environment according to at least one mark-up instruction.

Another embodiment involves a three-dimensional virtual world environment system. The system includes a user interface configured to load a selected style sheet and rendering objects from a memory, a renderer module configured to render the rendering objects and load the rendering objects in a queue, and an object processing module configured to modify style data of the rendered objects to modify the style of at least one level in the three-dimensional virtual world environment.

Yet another embodiment involves a computer program product for changing three-dimensional virtual world style. The computer program product includes a computer usable medium, including a computer readable program. The computer readable program, when executed on a computer, causes the computer to: create a three-dimensional style sheet by adding a plurality of mark-up tags to a body of data describing a virtual world environment, the mark-up tags including a plurality of modifiers, and modify the plurality of modifiers to change the style of the virtual world environment according to at least one mark-up instruction.

Other aspects and advantages of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

For a fuller understanding of the nature and advantages of the invention, as well as a preferred mode of use, reference should be made to the following detailed description, read in conjunction with the accompanying drawings, in which:

FIG. 1 illustrates a block diagram of a process for providing three-dimensional virtual world style sheets according to one embodiment of the invention;

FIG. 2 illustrates a illustrates an apparatus according to an embodiment;

FIG. 3 illustrates a system according to an embodiment;

FIG. 4A illustrates an example level of a three-dimensional environment using a first three-dimensional style sheet;

FIG. 4B illustrates a level of a three-dimensional environment using a second three-dimensional style sheet;

FIG. 5A illustrates the example mark-up for the first style sheet for the example shown in FIG. 4A; and.

FIG. 5B illustrates the example mark-up for the second style sheet for the example shown in FIG. 4B.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation, including meanings implied from the specification as well as meanings understood by those skilled in the art and/or as defined in dictionaries, treatises, etc.

The description may disclose several preferred embodiments of creating and modifying three-dimensional style sheets in a three-dimensional environment (e.g., a virtual world environment), as well as operation and/or component parts thereof. While the following description will be described in terms of virtual world style sheets for clarity and to place the invention in context, it should be kept in mind that the teachings herein may have broad application to all types of systems, devices and applications.

The invention provides a method and system for changing three-dimensional virtual world style. The method includes creating a three-dimensional style sheet by adding a plurality of mark-up tags to a body of data describing a virtual world environment, the mark-up tags including a plurality of modifiers, and modifying the plurality of modifiers to change the style of the virtual world environment according to at least one mark-up instruction.

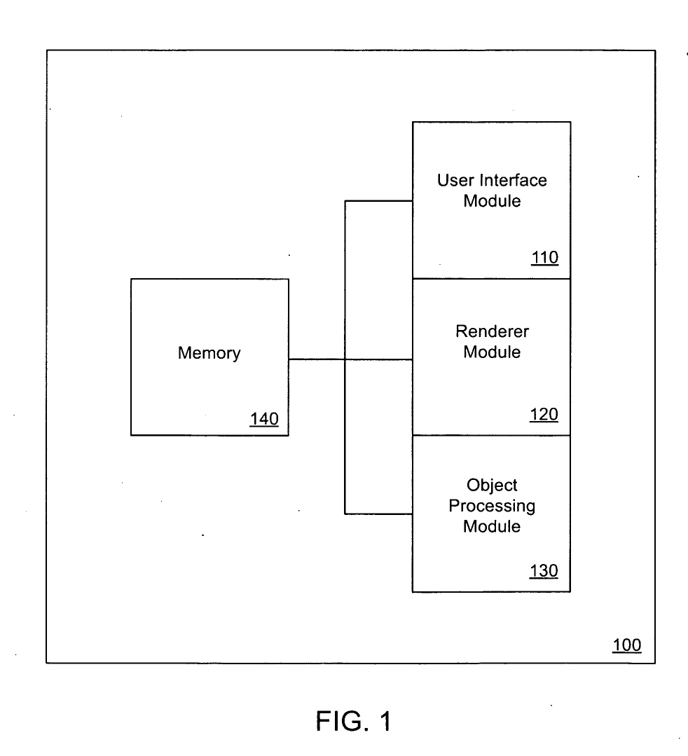

FIG. 1 illustrates a block diagram of a device 100 for providing three-dimensional style sheets. A Style Sheet (SS) is a list of statements (also known as rules) that can assign various rendering properties to mark-up (e.g., XML, HTML) elements. Style rules can be specified for a single element occurrence, multiple elements, an entire document/file, or even multiple documents/files at once. Many different rules can be specified for an element in different locations using different methods. All of these rules are collected and merged when the document/file is rendered to form a single style rule for each element.

In one embodiment of the invention, device 100 includes a user interface module 110, a renderer module 120, an object processing module 130 and a memory 140. In one embodiment of the invention, the renderer module 120 adds an organized set of mark-up tags to a body of data received from the memory 140 that describes the content of a three-dimensional (3-D) environment. In one embodiment of the invention, the 3-D content may be contained within a larger virtual setting. The elements that are described within the scope of the 3-D style sheet (3SS) will be modified and customized according to its mark-up tag instructions. The user interface module 110 allows a user to select different 3SS from a display and to make other selections in order to render a desired 3SS.

In one embodiment of the invention, the mark-up tags makes use of an underlying structure in the base data, such as the specification of objects as discrete, analyzable elements. In one embodiment of the invention, the base data is divided into mark-up delimited regions, such as areas in a room, or fittings/display banners as opposed to general content objects. In another embodiment of the invention, the tagging encapsulates the 3-D object data and should be interpreted before creating the representations of the annotated object in the given virtual environment.

In one embodiment of the invention, the mark-up tags include modifiers that specify instructions for modifying objects. In one embodiment of the invention, the instructions can be: expand or contract dimensions of objects in the 3-D environment, modify the distance between related elements; modify texturing and color/surface image display to be applied to objects; alternate versions to replace a given underlying object type, etc. In one embodiment of the invention, the alternate version may be a direct entry of the replacement object data or a reference to a file/data entry giving the object data required.

In one embodiment of the invention, a particular style might give an open, modern appearance of glass and steel to a building, while another might make the same general layout of rooms, tables and connecting spaces as a cramped and dark medieval space, with gothic arches and flickering torches. The underlying data would still specify hallways, main rooms, closets, illumination sources; only the implementation of these features would be over-ridden by the style sheet. A simpler example might replace the logos of one company with that of another and change the style of seating and desks for the two different 3SS applications. For more basic environments, the 3SS might simply specify simple colors or textures to distinguish between different areas, rather than using the full furnishings and graphical effects that a more advanced system might be able to support.

For ease of understanding, the following examples are presented. In this example for an embodiment of the invention, a 3-D base structure includes a two level building having one room with a raised address area on a lower level, a main room and a smaller room on the upper level. The complete building includes windows spaced around walls and a connector between the lower level and the main-room upper area. The lower level includes a raised display area at one end, a podium for a speaker, a backing display behind the podium mounted on a wall, seating blocks in a lower hall area, and a main entrance/exit. The upper level includes display racks in the main room, independent seating areas, a connecting door to the smaller room and an information display inside.

The first example rendering is a corporate chic style rendering. For the complete building, the floors are styled in smooth stone/marble; the walls and ceilings are colored light grey; the windows have large panes of clear glass in steel-edged rectangular frames; the connector is in the form of lift (e.g., an escalator or elevator) with buttons between the two levels. In the lower level, a speaker podium having a microphone and logo on the front of the podium; a banner with a corporate logo is located behind the podium; rows of chairs make up the seating blocks; and automatic doors with a corporate logo for the entrance/exit. In the upper level, display racks with gold trophies and industry awards are located around the walls; round steel tables with seats are positioned for the seating areas; a frosted glass door to the smaller area; and a video bulletin board displays information.

The second example rendering is a faux medieval rendering. For this rendering, for the whole building, the floors are styled in flagstones and straw; the walls and ceiling are displayed in grimy stone blocks; and a heavy wooden spiral staircase connects the two levels. The lower level includes an ornately decorated King's throne instead of a podium, a backing display is displayed as a hanging heraldic banner; the seating blocks are displayed as rows of rough wooden benches; and heavy metal-studded oak doors are displayed as the main entrance. The upper level includes displays of weaponry, armor and hunting trophies; fur-covered benches are displayed for seating; a lighter wooden door to the smaller room is displayed; a notice board and parchments/scrolls to display information are also displayed.

Other examples display objects, such as illumination sources. In the faux medieval 3SS rendering: for all ‘illumination-source’ elements, ‘torch’/‘fire’ elements replace other lighting elements. In one embodiment of the invention, specifications of which elements to render at what level of the virtual environment include: a ‘Dynamic Animated Fire Set’ to a ‘Fireplace with Fire Texture’ to a ‘Box Labeled Fire’ for different levels of display capability, etc. For general high-level modifiers to be applied to all elements of a specified type, an example includes for the corporate chic 3SS rendering: for all ‘glass [viewable pane]’ elements increase thickness by 25%, set interior view to: ‘transparent, green tinted’, set exterior view to ‘mirrored’, etc.

In one embodiment of the invention, the resources stored in the memory 140 that are needed by the render module 120 include an object listing and associated mark-up tags, 3SS attached for rendering and data files containing instructions for rendering. In one embodiment of the invention, the processing of device 100 begins with a start sequence that includes loading a 3SS and indexes all name-spaces present to refer back to during object processing by the object processing module 130. The object listings are loaded and the list of objects to be rendered at the top level are identified. The overall area is checked to determine if it has a name-space associated with it, and if so, the name-space is set as the active name-space.

In one embodiment of the invention, the renderer module 120 performs recursive rendering. In this embodiment of the invention, the renderer module identifies all objects to render at the current level and queues them for processing. For each object at the current level, the object is processed and the processed information is passed on for rendering. Any child objects of the current object is identified and placed on the end of the queue for processing. The rendering is repeated as many times as necessary.

In one embodiment of the invention, the object processing module 130 checks each object to determine if the object has a particular name-space associated with it. If the object does not have the particular name-space associated with it, the currently active name-space is used to process it. If the object does have the particular name-space associated with it, the current name-space is stored in memory 140 for later retrieval, and the current name-space is set to be the one specified by the object. In one embodiment of the invention, the object processing module 130 checks the current name-space for an object entry matching the current object, then refers to the object entry for attribute information that is appended to the basic information from the object. In one embodiment of the invention the basic information and the object entry information are appended together and the rendering information is outputted. In one embodiment of the invention, if the object was using a name-space specific to itself, the previous name-space is restored.

In one embodiment of the invention, when the object processing module 130 is processing objects to add style data, the processed information is fed to the renderer module 120 either one object at a time, or as batches of processed data for rendering, depending on the performance, and requirements of the set-up in question. In one embodiment of the invention, the base object data contains information on the location of the objects in question, and their general type, e.g., chair, wall, etc. In one embodiment of the invention, the object data contains actual 3D rendering information for the renderer module 120 to use. In another embodiment of the invention, the renderer module 120 relies on the 3SS information to describe what specifics to use, or where to search for the specific information, e.g., object/furniture/chair04, objs/building/walls/StoneandIvy, etc.

In one embodiment of the invention an example of a general mark-up for general objects is as follows (objects with an asterisk (*) denote multiple instances of a single object type, e.g., ‘chair*’ is equivalent to ‘chairs; and objects indented from a previous level are contained within/associated with the higher level):

```
parent
    child
Building
    Connector
    Windows
    Lower Level
        Main Hall
            Podium
            Backdrop
            Seating Block*
    Upper Level
        Main Room
            Display Rack*
            Seating Block*
        Smaller Room
            Information Display
```

In one embodiment of the invention, objects are associated with name-spaces in the 3SS mark-up language. In one embodiment of the invention, extensive mark-up language (XML) is used. In other embodiments, other types of mark-up language can be used, such as, Alternate Abstract Interface Markup Language (AAIML), Alternate User Interface Markup Language (AUIML), Hypertext Mark-up Language (HTML), etc.

In one embodiment of the invention, name-spaces may be nested. In this embodiment of the invention, a child name-space applies all the attributes of its parent, as well as further information of its own and may even over-ride the parent name-space's settings for certain specific attributes. Object tags specify information that is used to determine how to render an object of the type specified. In one embodiment of the invention, the information encompasses attribute tags that dictate what value or format to use to render each specified attribute of an object of that type. In one embodiment of the invention, an example of a mark-up including modifiers is as follows:

```
<name_space name=”Corporate Chic”>
    <object type=”floor”>
        <attribute att=“texture” value=”marble”/>
        <attribute att=”tiling” fit=”stretch”/>
    </object>
    <object type=”window”>
        <attribute att=”size” value=”large”/>
        <attribute att=”border” width=”thin” material=”steel”/>
    <object/>
    <object type=”seating”>
        <attribute att=”model” value=”steelchair08”/>
        <attribute att=”repeats” padding=”stretch” capacity=”8”/>
    <object/>
</name_space>
```

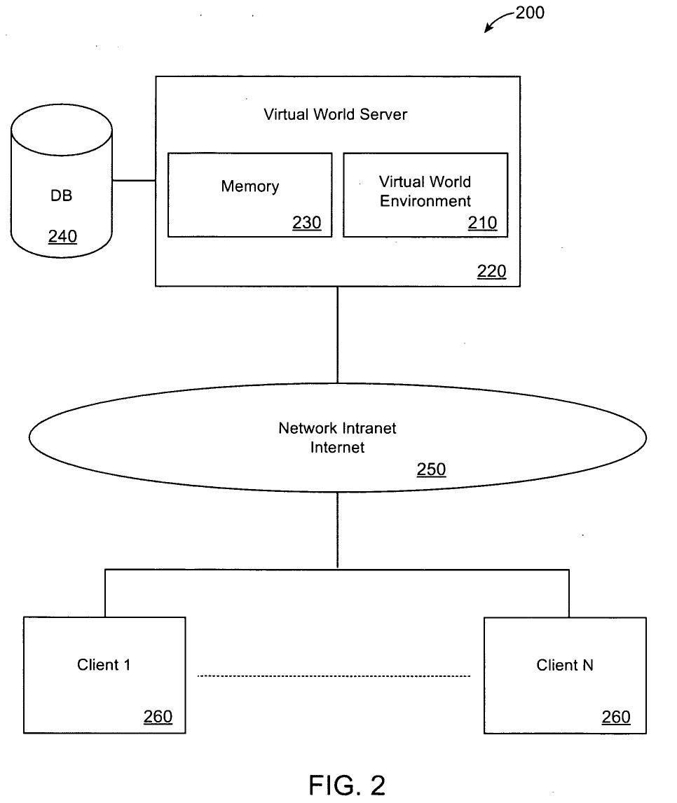

FIG. 2 illustrates a virtual world environment system 200. System 200 includes a virtual world environment 210, running on a virtual world server 220, having a memory 230, and connected with a database 240, a network/Intranet/Internet 250, and clients 1-N 260. In one embodiment, a user using a client 260 can create and select 3SS virtual world environment information locally on client 260, or on the virtual world server 220, using a device 100 or running a process (e.g., process 300).

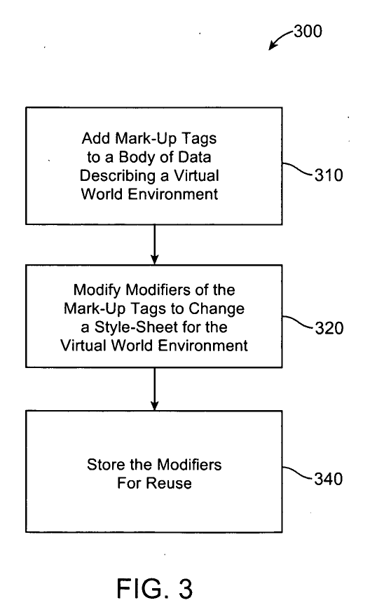

FIG. 3 illustrates a block diagram of process 300 which provides 3SS to a virtual world environment according to one embodiment. In block 310, markup-up tags are added to a body of data describing a virtual world environment. In block 320, modifiers of the mark-up tags are modified to change the 3SS for the virtual world environment. In block 340 the modifiers are stored in a memory for reusing the 3SS in a virtual world environment.

In one embodiment of the invention, the style sheet device/process addresses the customization of the presentation of content in 3-D spaces/virtual worlds. Given a set of data describing the 3-D content, the 3SS is applied to modify aspects of the data before displaying the final result in the virtual world. In one embodiment of the invention, the data being modified is in a standard format, such as X3D, corresponding to the XML or hypertext mark-up language (html) tagged text in a web page. This data is annotated in a description file, referencing the 3SS data to specify how to modify it for presentation. The 3SS allows for virtual worlds with different levels of display capabilities to present the same underlying data in whatever style was most suited. A 3SS selection allows a particular virtual area, or organization, to display everything covered under it in a unified look and feel.

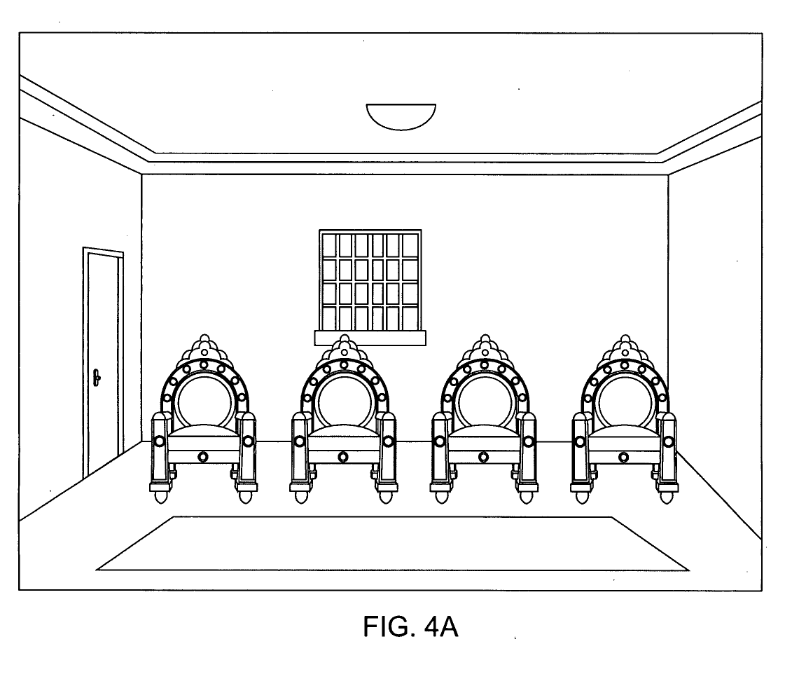

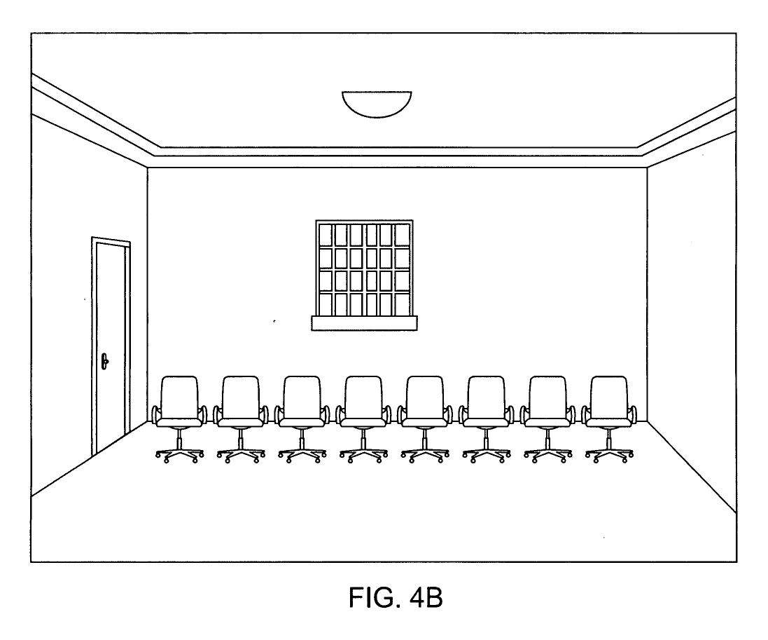

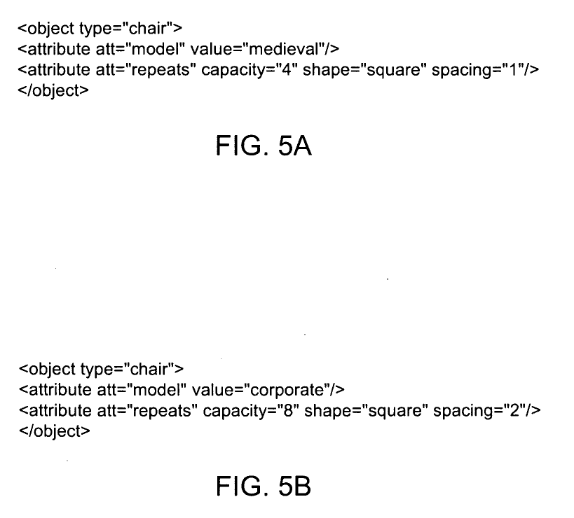

FIG. 4A illustrates an example level of a three-dimensional environment using a first three-dimensional style sheet. In the illustrated example, the room includes a door, a window, a light and four chairs having a medieval style. FIG. 5A illustrates the example mark-up for the first style sheet for the example shown in FIG. 4A.

FIG. 4B illustrates a level of a three-dimensional environment using a second three-dimensional style sheet. In this example, the four medieval chairs illustrated in FIG. 4A have been changed to eight corporate styled chairs. FIG. 5B illustrates the example mark-up for the second style sheet for the example shown in FIG. 4B.

The embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer, processing device, or any instruction execution system. For the purposes of this description, a computer-usable or computer readable medium can be any apparatus that can contain, store, communicate, or transport the program for use by or in connection with the instruction execution system, apparatus, or device.

The medium can be electronic, magnetic, optical, or a semiconductor system (or apparatus or device). Examples of a computer-readable medium include, but are not limited to, a semiconductor or solid state memory, magnetic tape, a removable computer diskette, a random access memory (RAM), a read-only memory (ROM), a rigid magnetic disk, an optical disk, etc. Current examples of optical disks include compact disk-read only memory (CD-ROM), compact disk-read/write (CD-R/W) and digital versatile disk (DVD).

I/O devices (including but not limited to keyboards, displays, pointing devices, etc.) can be connected to the system either directly or through intervening controllers. Network adapters may also be connected to the system to enable the data processing system to become connected to other data processing systems or remote printers or storage devices through intervening private or public networks. Modems, cable modem and Ethernet cards are just a few of the currently available types of network adapters.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method for changing three-dimensional virtual world style, the method comprising:
creating a three-dimensional style sheet by adding a plurality of mark-up tags to a body of data describing a virtual world environment, the mark-up tags including a plurality of modifiers; and
modifying the plurality of modifiers to change the style for the virtual world environment according to at least one mark-up instruction.

2. The method of claim 1, wherein the modifiers contain information to modify dimensions of an object in the virtual world environment.

3. The method of claim 1, wherein the modifiers contain information to modify distance between objects in the virtual world environment.

4. The method of claim 1, wherein the modifiers contain information to modify colors and texture of at least one object in the virtual world environment.

5. The method of claim 1, wherein the modifiers contain information to modify illumination source elements in the virtual world environment.

6. The method of claim 1, wherein the modifiers contain information to modify a theme in the virtual world environment.

7. The method of claim 1, wherein the modifiers contain information to modify at least one specific region in the virtual world environment.

8. A three-dimensional virtual world environment system, comprising:
a user interface configured to load a selected style sheet and rendering objects from a memory;
a renderer module configured to render the rendering objects and load the rendering objects in a queue; and
an object processing module configured to modify style data of the rendered objects to modify the style of at least one level in the three-dimensional virtual world environment.

9. The system of claim 8, wherein the rendering objects include location information and type of the objects.

10. The system of claim 8, wherein the rendering module determines child objects of the rendering objects.

11. The system of claim 8, wherein the object processing module modifies a theme for the at least one level of the virtual world environment.

12. The system of claim 8, wherein the object processing module modifies dimensions of the rendered objects in the at least one level of the virtual world environment.

13. The system of claim 8, further comprising a server configured to execute the three-dimensional virtual world environment and a client device coupled to the server and configured to display the user interface.

14. A computer program product for changing three-dimensional virtual world style comprising a computer usable medium including a computer readable program, wherein the computer readable program when executed on a computer causes the computer to:
create a three-dimensional style sheet by adding a plurality of mark-up tags to a body of data describing a virtual world environment, the mark-up tags including a plurality of modifiers; and
modify the plurality of modifiers to change the style of the virtual world environment according to at least one mark-up instruction.

15. The computer program product of claim 14, wherein the modifiers contain information to modify dimensions of an object in the virtual world environment.

16. The computer program product of claim 14, wherein the modifiers contain information to modify distance between objects in the virtual world environment.

17. The computer program product of claim 14, wherein the modifiers contain information to modify colors and texture of at least one object in the virtual world environment.

18. The computer program product of claim 14, wherein the modifiers contain information to modify illumination source elements in the virtual world environment.

19. The computer program product of claim 14, wherein the modifiers contain information to modify a theme in the virtual world environment.

20. The computer program product of claim 14, wherein the modifiers contain information to modify at least one specific region in the virtual world environment.
